(19) United States
(12) Patent Application Publication
(10) Pub. No.: US 2009/0193679 A1
(43) Pub. Date: Aug. 6, 2009

(54) METHOD AND SYSTEM FOR ROASTING A BIOMASS FEEDSTOCK

(76) Inventor: Raymond Guyomarc'h, Saint Theodorit (FR)

Correspondence Address: GREER, BURNS & CRAIN, 300 S WACKER DR, 25TH FLOOR, CHICAGO, IL, 60606, US

(21) Appl. No.: 12/306,839

(22) PCT Filed: Jun. 28, 2007
(86) PCT No.: PCT/FR2007/001086

§ 371 Date: Dec. 29, 2008

(30) Foreign Application Priority Data
Jun. 29, 2006 (FR) 0605840

(51) Int. Cl. F26B 3/06; F26B 11/04; F26B 21/04; F26B 21/14; F26B 23/02

(52) U.S. Cl. 34/467; 34/516; 34/472; 34/477; 34/514; 34/77; 34/131; 34/132; 34/499

(57) ABSTRACT

A method for roasting a load of plant biomass, includes the following stages: generation of a treatment gas stream by a thermal generating apparatus, the treatment gas stream being an inert gas consisting essentially of CO₂; generation of a bed of material at high temperature, called the thermal base; treatment of the load of biomass with the treatment gas stream, the treatment gas stream being laden with gaseous components including a water steam and volatile organic compounds originating from the load of biomass during the treatment; and recycling of at least a portion of the water steam by passing at least a portion of the laden gas stream through the thermal base.

The present invention relates to a method and a system for roasting a load of plant biomass and more particularly a load of wood.

The field of the invention is the field of roasting a load of plant biomass and in particular a load of wood.

Plant biomass is a renewable raw material whose energy potential, released on combustion, is very similar to that of coal. Depending on its manner of thermal upgrading, plant biomass can have an energy efficiency from 35% to 100%. This is due to the “hydrophilicity” of the plant fibres, which soak up water, removal of which consumes energy. The average lower heating value (LHV) of dry plant biomass is about 18 100 kJ/kg.

By applying certain methodologies for thermal upgrading to plant biomass, the final product can be brought up to the theoretical value of its higher heating value (HHV), i.e. 32 750 kJ/kg. This increase in energy potential is peculiar to plant biomass and more particularly to its chemical characteristics. This increase in HHV per kilogram of final product is originating by degradation of the starting biomass, at the expense of its original intrinsic energy value. Thus, it is found that the HHV of the combustible components of 1 kg of anhydrous biomass can reach an average value of 23 600 kJ/kg. The same dried biomass, in the current process conditions, has a usual average HHV of 19 100 kJ/kg.

One of the principles of optimization is to reduce the amount of oxygen contained in the anhydrous matter, so as to increase the percentage by weight of carbon. Roasting is one of the methods currently used for achieving this result.

For roasting, a load of biomass must be heated to temperatures between 280 and 320° C. These are high temperatures, and the energy consumed in heating a load of wood to these temperatures is considerable and puts a strain on the overall efficiency of the methods of roasting used at present.

One of the objectives of the invention is to propose a method and a system for roasting a load of plant biomass offering better yield than the methods and systems currently in use.

Another objective of the invention is to propose a method and system for roasting a load of plant biomass which requires less external energy supply for roasting a load of biomass than the existing methods and systems.

Another objective of the invention is to propose a method and a system for roasting that displays optimum environmental performance, better than with the existing roasting systems.

The invention proposes overcoming the aforementioned problems by a method for roasting a load of plant biomass, comprising the following stages:
generation of a treatment gas stream by thermal generating means;
generation of a bed of material at high temperature, called the thermal base;
treatment of said load of biomass with said treatment gas stream, said treatment gas stream being laden with gaseous components comprising water steam and combustible pyrolysis gases originating from said load of biomass during said treatment; and
recycling of at least a portion of said water steam by passing at least a portion of said laden gas stream through said thermal base.

The method according to the invention employs a thermal base composed essentially of a bed of material at high temperature. This layer of material at high temperature is then used for recycling the treatment gas stream laden with gaseous components and in particular water steam. The recycling of the treatment gas stream makes it possible to recover some of the energy contained in the laden gas stream by passing the laden gas stream through the thermal base. Such a recycling can provide better roasting efficiency/yield, a decrease in energy of the external energy supply required for roasting, and less pollution in comparison with the existing roasting methods and systems.

In a particular embodiment of the method according to the invention, the thermal base is composed essentially of an optimized load of plant biomass, combustion of which is carried out under optimum conditions, allowing high temperatures to be obtained. This layer of material at high temperature is then used for recycling the gas stream used in the treatment method according to the invention. This stream is laden with gaseous components after treatment of the biomass that is to be roasted, in particular with water steam, contained in the raw material, and organic compounds, gasified in the course of roasting. By recycling the treatment gas stream it is possible to recover some of the energy contained in the water steam, extracted from the starting biomass. Passage of the gas stream, laden with pyrolysis gases containing volatile organic compounds (VOC), through the thermal base permits their combustion at high temperature and utilization of the energy released. This recycling optimizes the efficiency of roasting of the plant biomass and protects the environment:
the recycling of the water steam extracted from the raw material and recovery of the energy applied for its extraction, greatly reduces the consumption of energy employed in the method,
the combustion of the organic compounds gasified in the course of the roasting process can be complete. It is carried out while the organic compounds are at high temperature, therefore in the gaseous state, without any elementary condensation being possible. Their combustion is stoichiometric and can be without impact on the environment,
the energy released by the combustion of the organic compounds can satisfy the needs of the roasting process,
the residual energy is greater than that employed in initiating the process and can benefit other applications, by replacing the energy that they use or would use.

Advantageously the treatment gas stream is essentially composed of CO₂.

Moreover, the thermal base generated in the method according to the invention is essentially composed of carbon-containing constituents at high temperature.

The generation of the thermal base can comprise combustion of roasted biomass under O₂, said combustion producing carbon-containing constituents at high temperature. The biomass used as fuel can be of vegetable or animal type or of any other type.

The reactive thermal base according to the invention can be burning at a temperature that is controlled by injection of oxygen in the centre of said thermal base. This injection of oxygen can serve for controlling the temperature and the production of energy within the thermal base.

The method according to the invention can comprise co-generation of electricity from the water steam originating from a cooling circuit or from any other circuit that can be employed in the method according to the invention. The methods of co-generation of electricity from water steam are well known to a person skilled in the art.

The method according to the invention can in addition comprise combustion, during passage of the laden gas stream through the thermal base, of organic gaseous components originating from the load of biomass and present in the laden gas stream, this combustion producing thermal energy that can be used directly in the method and/or electric power by means of dedicated systems. The thermal energy produced can be used for roasting a new load of wood.

Advantageously, the method according to the invention can comprise recycling of the laden gas stream to recover gas that is suitable for use in the treatment gas stream. The recovered gas can be heat-transfer CO₂.

This recycling can comprise filtering of the laden gas stream, after passage of the stream through the thermal base. This filtering can have the purpose of removing unburnt compounds during passage of the laden gas stream through the thermal base.

In a particular version of the invention, generation of the gas stream for roasting can comprise combustion of roasted biomass under O₂, this combustion producing a combustion gas essentially comprising CO₂. The roasted biomass can be plant biomass. In a particular version of the method according to the invention, the roasted biomass used for generating the gas stream and/or for generating the thermal base can be roasted plant biomass obtained by roasting plant biomass by the method according to the invention.

After a combustion gas has been obtained, the method according to the invention can comprise a preliminary phase of condensation of elements contained in the combustion gas, for recovery of a residual gas comprising carbon dioxide, this condensation in particular having the purpose of removing the water steam contained in the combustion gas.

The method according to the invention can in particular comprise compression of the residual gas, for condensing and recovering the carbon dioxide in liquid phase.

The residual gas can also travel through at least one heat exchanger so that it is raised to the treatment temperature, and can then returned to the treatment cycle, to be used in the treatment of the load of biomass to be roasted.

The thermal energy required to heat the residual gas to the treatment temperature can be obtained by combustion of roasted biomass, in particular of roasted biomass obtained by the method according to the invention, and by the combustion of the volatile organic compounds.

In a particularly advantageous version of the invention, the treatment gas stream can be generated by combustion of a solid fuel, said combustion also generating at least a portion of the thermal base.

According to another aspect of the invention, a system for roasting a load of plant biomass is proposed, comprising:
generating means provided for generating a treatment gas stream and a bed of material at high temperature, called the thermal base;
a treatment unit, provided for receiving said load of biomass and subjecting it to said treatment gas stream, said treatment unit comprising a treatment furnace and means for feeding the load of biomass into said treatment furnace and for removing said load of biomass from said treatment furnace;
means for gaseous exchange provided for communication between the generating means and the treatment unit

The generating means comprise a device for combustion of a solid fuel provided for generating the treatment gas stream by combustion of said fuel.

The generating means also comprise a device for combustion of a solid fuel, arranged in such a way that the combustion of said solid fuel forms at least a portion of the thermal base.

In a particularly advantageous variant of the invention, the generating means comprise a thermal generator provided for generating at least a portion of the treatment gas stream, said generator also being provided for generating at least a portion of the thermal base.

The thermal generator can comprise a thermal reactor or a solid-fuel furnace or a hybrid device, allowing the combustion of a solid fuel, in particular of roasted plant biomass, this combustion producing, on the one hand, a combustion gas stream of which at least a part can be used as treatment gas stream, and on the other hand, carbon-containing constituents at high temperature, at least a portion of which can be used for producing the bed of material at high temperature called the thermal base.

Advantageously, the thermal generator can be equipped with a system for cooling by circulation of a heat-transfer fluid. The generator can comprise double walls, between which the heat-transfer liquid, for example water under pressure, can circulate. The heat-transfer liquid can also be sprayed onto the walls of the thermal generator.

In a particular variant of the invention, the thermal generator can comprise a grate-type furnace intended to receive the thermal base and arranged for effecting transfer of the laden gases originating from the treatment unit.

The grate-type furnace can advantageously be equipped with a system for cooling by circulation of a heat-transfer fluid in the furnace grate.

The thermal generator can also comprise means for injecting oxygen. The injection of oxygen can, on the one hand, provide combustion of a solid fuel intended for the generation of the treatment gas stream and/or of the thermal base, and on the other hand for regulating the temperature in the thermal base.

The thermal generator can in particular comprise a chamber for post-combustion of pyrolysis gases generated by the roasting of the load of biomass and/or by the incomplete combustion of a solid fuel. This post-combustion chamber is employed in particular for combustion of the volatile organic compounds and the pyrolysis gases.

Advantageously, the thermal generator can comprise at least one heat exchanger, said heat exchanger being provided for effecting heat exchange between either a combustion gas and the treatment gas stream, or a fluid composed essentially of saturated water steam and superheated water and the treatment gas stream, this fluid being essentially composed of water steam that comes either from roasting of the load of biomass, or from a circuit for cooling a part of the system.

The treatment furnace according to the invention can be a cylindrical assembly comprising an inner cylinder housed in an outer cylinder defining a space for treatment of the load of biomass, said inner cylinder receiving the load of plant biomass that is to be roasted.

The inner cylinder can in particular be provided with freedom to rotate about a longitudinal axis relative to the outer cylinder.

The wall forming the inner cylinder can advantageously be perforated, in such a way that, on the one hand, the treatment gas can be fed into this cylinder and come in contact with the load of biomass to be treated, and on the other hand, the laden gas can leave this cylinder after treatment of the load of biomass.

Moreover, the inner cylinder can comprise at least one protuberance on its inside wall, over almost the entire length of the inside wall, said protuberance ensuring the entrainment and mixing of the load of biomass during the treatment. Contact of the treatment gas with the load of biomass is thus facilitated and treatment of the load of biomass is improved. After treatment, mixing of the treated load of wood facilitates the release of the laden treatment gas.

In an advantageous version of the system according to the invention, the outer cylinder can comprise a heat-insulated shell limiting the heat losses and increasing system security.

The outer cylinder can moreover comprise a solid inside wall enveloping the inner cylinder and delimiting the space for treatment of the load of biomass. This inside wall defines the treatment space that is in contact with the various gas streams.

Advantageously, the treatment furnace can comprise a deflector on almost the entire length of the cylinder, intended for directing the treatment gas stream towards the lower portion of the treatment space so as to distribute said stream onto all of the biomass load.

The treatment furnace can comprise at least two brushes mounted in contact, on the one hand, with the inside wall of the outer cylinder, and on the other hand, between the outside wall of the inner cylinder in order to delimit a zone for feed of the treatment gas stream into the treatment furnace and a zone for withdrawal of the gas stream after treatment of the load of biomass.

These brushes can advantageously be arranged for brushing the outside wall of the inner cylinder so as to dislodge particles of the load of biomass retained on the inner cylinder.

The treatment furnace additionally comprises a pipe for feed of the treatment gas stream into the treatment space. This pipe for feed of the gas stream can be heat-insulated by the methods and systems known by a person skilled in the art.

The treatment furnace also comprises a pipe for withdrawal of the treatment gas stream. This pipe for withdrawal of the treatment gas stream can be heat-insulated.

The treatment furnace can advantageously comprise a pipe for injecting liquid CO₂ into the treatment zone. This pipe for injecting CO₂ is provided for safety reasons and for regulating the temperature within the space for treatment of the load of plant biomass.

In a particular embodiment the treatment unit can comprise driving means arranged for providing rotation of the inner cylinder about a longitudinal axis. These rotating means, by effecting rotation of the inner cylinder, provide mixing of the load of biomass present in the inner cylinder.

According to a particular embodiment of the system according to the invention, one end of the inner cylinder and of the outer cylinder is provided with an opening for feeding the load of biomass into the inner cylinder before treatment and for extracting the load of biomass after the treatment, the other end being closed.

During treatment of the load of biomass, this opening is tightly closed by piston-actuated sealing means.

The treatment unit can moreover comprise means for horizontal positioning of the treatment furnace. These positioning means allow the treatment unit to move to a horizontal position, said position being maintained during treatment of the load of wood.

The treatment unit can moreover comprise means arranged for rotation of the cylindrical assembly about a horizontal axis. These rotating means are arranged for positioning the treatment unit in particular positions for charging and discharging of the load of biomass.

The treatment unit can advantageously comprise means for receiving the load of biomass after treatment. These receiving means can comprise a receiving tank or a receiving wagon.

In one position, called the charging position, the cylindrical assembly is positioned vertically, the end having an opening in the inner and outer cylinders being at the top, in such a way that the load of biomass to be treated can be fed into the inner cylinder. This position can be used advantageously for dismounting the cylindrical assembly, or one of the cylinders of the treatment unit, for maintenance operations. This position permits very practical and very ergonomic charging of the wood load directly into the inner cylinder.

In one position, called the discharging position, the cylindrical assembly is positioned vertically, the end having an opening in the inner and outer cylinders being placed near the bottom, in such a way that the treated biomass load is collected in receiving means. This discharging position permits practical and simple discharging of the load of biomass into means for receiving the load of biomass.

In another position, called the processing position, the cylindrical assembly is positioned horizontally, the opening in the inner and outer cylinders being tightly closed by the sealing means.

The system according to the invention can moreover comprise means for extracting the gas mixture from the treatment space for keeping said treatment space permanently at low pressure. These extracting means can comprise means allowing aspiration of the treatment gas stream and can be positioned downstream of the treatment space and connected to the pipe for withdrawing the laden gas stream.

The system according to the invention can further comprise a water steam generating device, utilizing the thermal energy from any element of the system.

Advantageously, the system according to the invention can comprise means for co-generation or for tri-generation of energy from the recovered thermal energy.

The system according to the invention can in addition comprise means for storage and/or distribution of O₂ and means for storage and/or liquefaction and/or distribution of CO₂.

Other advantages and characteristics of the invention will become apparent on examination of the detailed description of an embodiment which is in no way limitative, and the attached drawings in which:

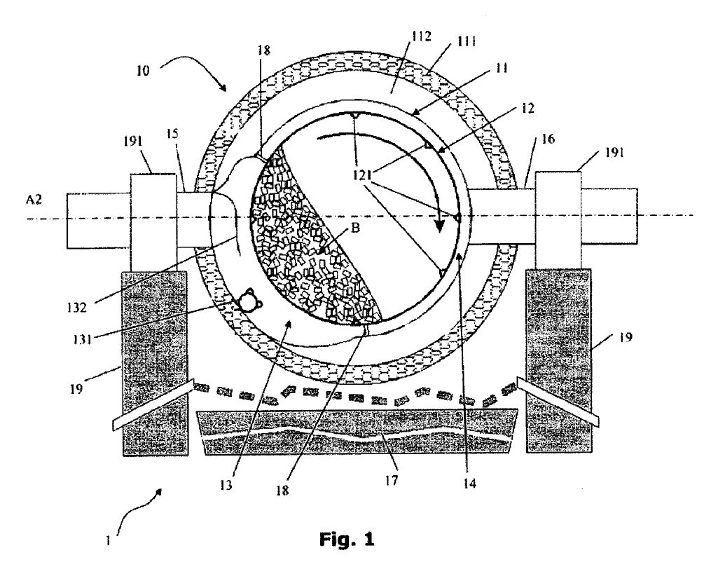

FIG. 1 is a diagrammatic representation of a cross-sectional view of a treatment unit according to the invention;

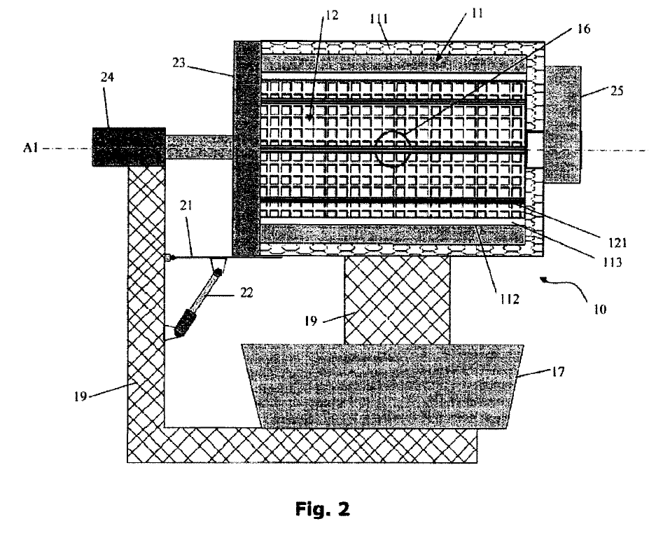

FIG. 2 is a diagrammatic representation of a view in longitudinal section of a treatment unit according to the invention;

FIG. 3 is a diagrammatic representation of a treatment unit in side view of a treatment unit according to the invention;

FIG. 4 is a diagrammatic representation of a treatment unit of a view of the opposite side of a treatment unit according to the invention;

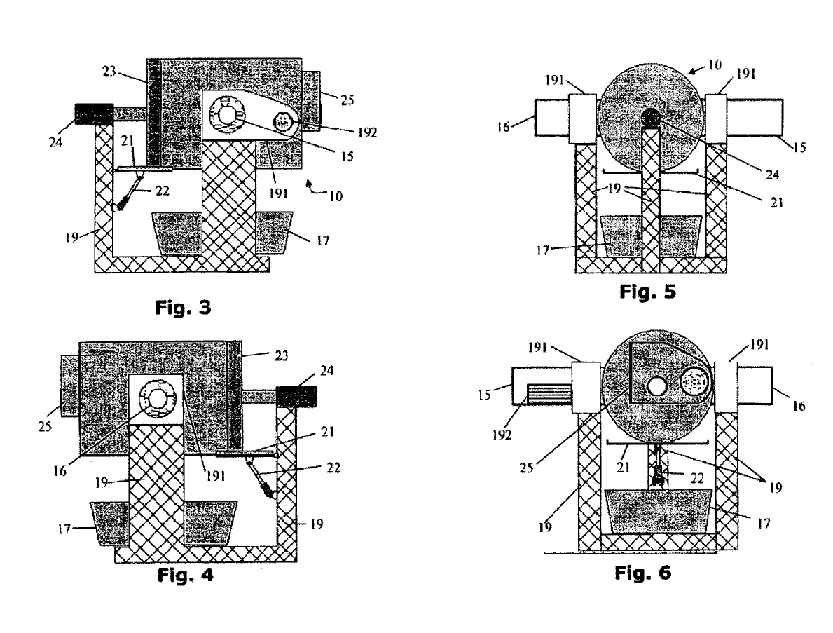

FIG. 5 is a diagrammatic representation of a treatment unit according to the invention viewed from the front;

FIG. 6 is a diagrammatic representation of a treatment unit according to the invention viewed from the rear;

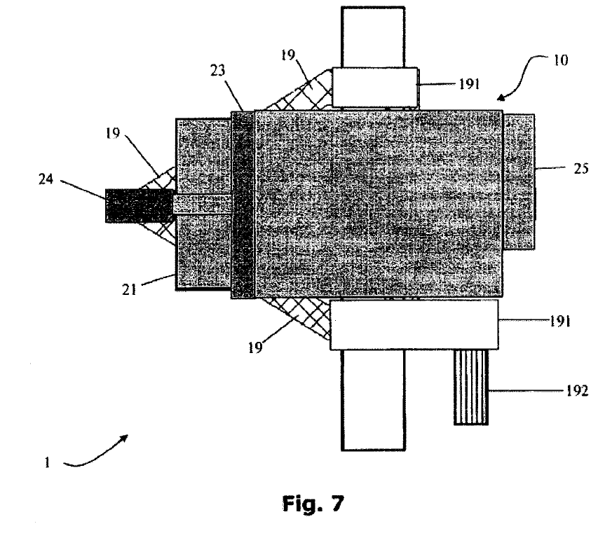

FIG. 7 is a diagrammatic representation of a top view of a treatment unit according to the invention;

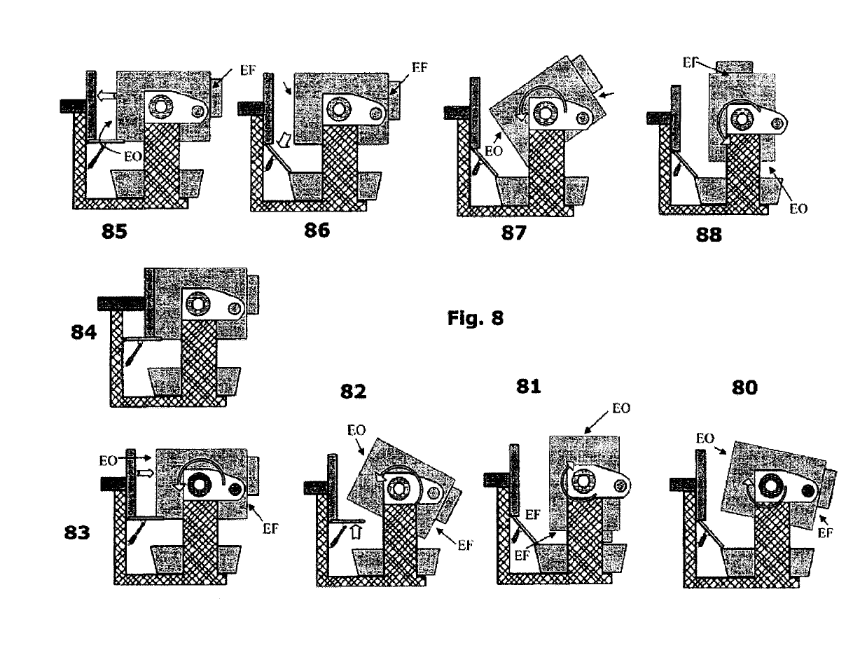

FIG. 8 presents several diagrammatic representations of the treatment unit in swivelling mode, all said representations being based on a side view of the treatment unit;

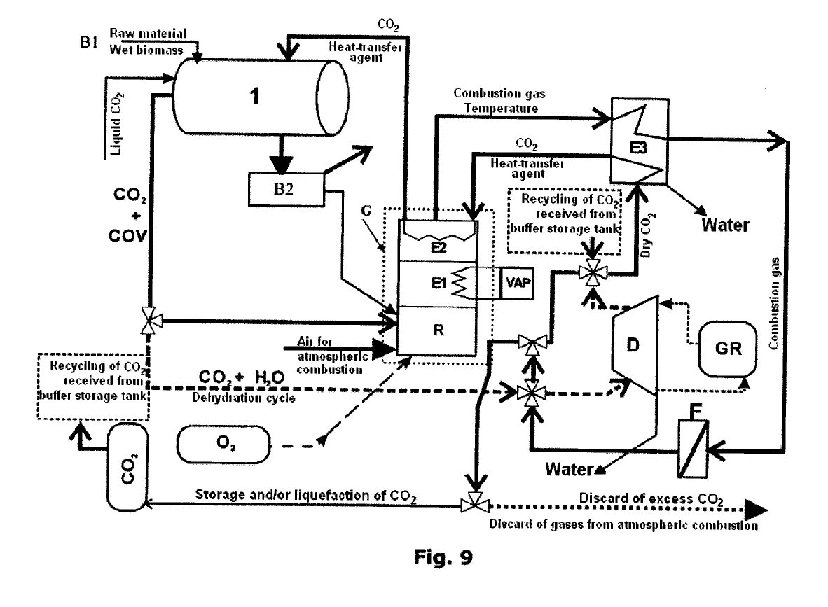

FIG. 9 is a diagrammatic representation of a system for roasting according to the invention;

The example discussed below is a particular, non-limitative example of the present invention. It relates to a system for roasting a load of plant biomass and more particularly a load of wood.

The system described in the present example comprises a treatment unit 1 as shown in FIGS. 1 to 7 in various views. These various diagrams show a treatment furnace 10 which is in the form of a cylindrical assembly, comprising an outer cylinder 11 and an inner cylinder 12. The treatment furnace 10 is able to swivel about a horizontal axis A2 for charging the wet wood load B1 and for discharging the roasted wood load B2. In addition, the inner cylinder 12 is able to rotate, relative to the outer cylinder 11, about the longitudinal axis A1 shown in FIG. 2. The outer cylinder 11 is fixed. The inner cylinder 12 is formed from a perforated wall and a solid bottom, into which the wet wood load B1 to be treated is fed. FIG. 1 shows the wood load B as it is entrained by the rotation of the inner cylinder 12. The inner cylinder 12 has protuberances 121 in the treatment zone, which ensures entrainment and mixing of the wood load B to be roasted.

The outer cylinder 11 has a solid inner wall, which envelops the perforated inner cylinder 12 for roasting, and it is in the zone delimited by this cylinder 11 that the stream of heat-transfer gas (composed essentially of CO₂) is introduced and withdrawn. This zone is called the treatment space.

The treatment space is separated into two parts, 13 and 14, by special high-temperature brushes 18. This space is thus divided into two zones, namely:
the inlet zone 13 corresponding to the zone for introduction of the heat-transfer gas stream which will travel through the load of biomass B;
the outlet zone 14 corresponding to the zone for withdrawal of the laden gas stream, composed of the heat-transfer CO₂ and moisture and/or pyrolysis gases extracted from the wood to be roasted.

The inlet zone 13 of the treatment gas stream also corresponds to a zone for expansion and distribution of the hot, dry heat-transfer CO₂, the gas being distributed over the entire outside surface of the rotating perforated inner cylinder 12 corresponding to the surface occupied by the load of wood to be roasted.

The outlet zone 14 corresponds to the treatment space not occupied by the wood load to be roasted downstream of the industrial brushes 18. The hot, dry heat-transfer CO₂ that is fed into zone 13 passes through the wood to be roasted, in which it will transfer its thermal energy to the wood load B by the three known methods of heat transfer:
conduction
convection
radiation

But also by a fourth heat transfer method: that of osmosis of the CO₂ with the moisture contained in the biomass that is to be roasted. After passing through the wood, the heat-transfer gas stream entrains:
the moisture evaporated from the wood, during the dehydration phase
the pyrolysis gases “VOC” during the roasting phase.

The laden gas stream is then drawn through the perforations of the inner cylinder 12 and is extracted via the outlet pipe 16.

The brushes 18 are arranged over the entire length of the cylinder of the inside wall of the outer cylinder 11 at the junctions of the inlet zone 13 and outlet zone 14. These industrial brushes 18 are detachable so that they can be replaced if they are worn; their role is to separate the treatment space into two zones and to provide constant brushing of the outside wall of the inner cylinder 12 to dislodge particles of wood that could be retained by the perforations present on said cylinder 12.

The treatment furnace 10 also comprises a heat-insulated outer shell, which corresponds to the outside wall 111 of the outer cylinder 11. The furnace 10 can also have a buffer zone 112, and this too can be heat-insulated.

The treatment furnace 10 also comprises an inlet pipe 15 of the high-temperature heat-transfer gas stream, this pipe 15 and the opposite outlet pipe 16 for the laden gas stream are integral with the outer cylinder 11. They swivel in the supports 191 when the roaster is tilted for charging with wet wood B1 or for discharge of roasted wood B2. The roasted wood B2 is received at the end of treatment in the detachable tank 17.

The outlet pipe for the laden gas stream (i.e. the treatment gas stream and, depending on the phase of the treatment, the moisture from the wood or the pyrolysis gases) can be supplemented with an electric extractor (not shown) which maintains a constant low pressure in the roaster.

The pipes 15 and 16 are heat-insulated. They are connected to fixed pipelines (not shown), for feed of the heat-transfer gas stream and for extraction of the treatment gas, from the recycling loop leaving the heat exchangers and returning to the thermal generator.

The treatment furnace 10 also comprises at least one deflector 132 which directs the heat-transfer gas stream to the bottom portion of the inner cylinder 12 containing the wood load B to provide distribution throughout the mass of wood to be roasted.

The treatment furnace 10 further comprises a pipe 131 for injection of liquid CO₂, the purpose of said pipe being:
to ensure safety of the treatment unit 1 by neutralizing any risk of ignition of the biomass during roasting,
to provide cooling of the roasted wood at the end of treatment, to lower its temperature to values below any possibility of self-ignition in the open air. During the cooling phase:
   the inner cylinder 12 continues rotating, for even distribution of the liquid CO₂ that will capture, through the hot roasted wood, its latent heat of evaporation;
   feed of heat-transfer CO₂ is cut off;
   extraction of the laden gas stream continues until the desired temperature is obtained.

The pipe 131 for injection of liquid CO₂ is connected to a system for distribution of liquid CO₂ under pressure, shown diagrammatically in FIG. 9, and an automatic safety valve (not shown) provides the safety and cooling functions in case of a power cut.

The treatment unit 1 comprises fixed supports 19 for the roasting furnace 10 which receive the means 191 and 192 that enable the furnace 10 to swivel about the axis A2. The height of said supports 19 permits tilting of the roasting furnace 10, above the receiving tank 17 for the roasted wood during its rotation in the vertical positions for charging and discharging of the roasted wood load.

The swivelling of furnace 10 about the axis A2 is provided by the rotating means 191 and 192 which can comprise a chain-driven electric mechanism or any other known means, positioned on one of the supports. The pipes 15 and 16 are the shafts for support and swivelling/rotation of the roasting furnace.

The supports 19, as shown in FIG. 7, are in the form of a chassis stabilized by at least three feet:
two feet supporting the rotating means 191 and 192,
at least one foot receiving the sealing means 23 and 24 of the open end as well as the means 21 and 22 for horizontal positioning of the furnace 10.

The sealing means comprise a piston 24 which pushes a plug/a door 23 against the open ends of cylinders 11 and 12 of the roasting furnace 10 to close them tightly during treatment of a wood load B.

The means for horizontal positioning of the roasting furnace comprise:
a plate 21 which is dimensioned to the diameter of the roasting furnace and corresponds to the useful distance for assuming the following positions:
   a first horizontal position when a load of wood is undergoing treatment;
   a second tilted position when it releases the roasting furnace, either for discharge of a roasted wood load or for charging a load of wood to be roasted. In the discharge position, plate 21 connects to the receiving tank 17 and thus serves as a chute for receiving the roasted wood load, once door 23 is opened.
a piston 22 which controls the positions of plate 21.

The rotation of cylinder 12 within the treatment furnace 10 about axis A1 is provided by a mechanism with an electric motor 25.

FIG. 8 shows the treatment/roasting furnace 10 in the swivelling positions which allows it to be positioned:
in the charging phase;
in the roasting phase; and
in the discharge/extraction phase.

FIG. 8 shows the different positions of furnace 10 during a complete treatment cycle:
positions 80 and 81: The furnace tilts to the vertical position, with the open end EO at the top, and the closed end EF at the bottom, for feed of a new charge of wood B to be roasted;
position 82: furnace 10 tilts to its position for roasting a load of wood, corresponding to position 84;
position 82 and 83: plate 21 returns to its horizontal position and controls the positioning of furnace 10 in the roasting position;
position 83 and 84: door/plug 23 closes hermetically, treatment of the load wood B can be carried out;
position 85: door/plug 23 opens, roasted wood can flow onto the positioning plate 21;
position 86: positioning plate 21 swivels to form a chute to the receiving tank 17. The roasting furnace 10 can swivel;
positions 87 and 88: roasting furnace 10 tilts to the vertical position, with the open end EO at the bottom and the closed end EF at the top, for transfer/extraction/discharging of roasted wood into the receiving tank 17.

An example of a system for roasting a load of wood according to the invention and its principle of operation are shown in FIG. 9. It comprises a roasting unit 1 as described above. The roasting unit 1 receives the wood to be roasted B1, in the form of forestry chips, by-products and related shredded products as well as ground products with the same dimensions as sawdust.

The roasting system as shown in FIG. 9 also comprises a thermal generator G. It is a thermal generator with boiler for the production of high-pressure water steam and exchangers: gas/water and gas/gas. The thermal generator G comprises:
a thermal reactor R of high efficiency. This reactor receives at least a portion of the roasted wood B2 on a grate in order to form a bed of solid fuel, which will be supplied with industrial oxygen as supporter of combustion. This is the reactive “thermal base”. This “thermal base” is fed continuously with roasted wood, with injection of O₂ to produce a seat of combustion for a high-temperature reactor. By controlling the injection of O₂, combustion of the “thermal base” is arranged to provide the reactions required for:
   the thermal capacity for roasting the wood, and optionally
   high-output water steam generation,
The cycle is organized for optimum production of thermal energy in all the sources of the system, as well as the recycling and optimum utilization of the energy generated by the method.
a heat exchanger E1, or water steam boiler: the water for thermal control of the reactor walls is vaporized in this exchanger and then injected into a water steam-turbine alternator and/or a storage tank. The temperature and pressure of this water steam are determined by the combustion temperature in the reactor R. All of the parameters can be adjusted by modifying the thermal reaction of the reactor by controlling the injection of O₂. The heat-transfer gas stream acquires its thermal load in an optimum manner in this exchanger, for rapid exchange of sensible heat.
a gas/gas heat exchanger E2, for the laden gas stream, combustion gas+heat-transfer gas laden with recycle CO₂ which then acquires its temperature of heat-transfer treatment gas stream for roasting.

The system also comprises a gas/gas heat exchanger E3 (whose purpose is to cool the combustible gases) in which the laden gas stream exchanges the residual thermal capacity (that it acquired on passing through the thermal reactor R and the residual heat from the treatment furnace 10) with the cold, dry heat-transfer CO₂ arriving from the dehydrator D. At least a portion of the water steam (extracted from the load of wood to be roasted) is condensed in this exchanger E3, its latent heat of condensation thus being recovered.

In FIG. 9, F represents a dust filter. The laden gas stream coming from the thermal reactor R is likely to be carrying carbon dust, which will be trapped here, and this combustible dust is then burnt with the biomass from reactor R.

Also in FIG. 9, GR and D represent a system for dehydration, which is made up of two elements:
the refrigeration unit GR and
the refrigerant condenser D where the gas mixture, laden with water steam (extracted from the load of wood to be roasted) from the roaster 1, is cooled and dried.

The roasting system advantageously comprises an O₂ system for storage and distribution of the oxygen for supporting combustion. The consumption of oxygen, as supporter of combustion of the “thermal base”, is related to the power used.

Finally the system can comprise a water steam generating device VAP. The production of water steam has several possible functions:
1. High-pressure water steam for a turboalternator;
2. Water steam for energy storage; or
3. Water steam for dissipating excess energy: in this device the water recovered in the dehydrator D, during the dehydration phase, is evaporated in exchanger E1, which is “open-mouthed” i.e. open to the open air (or escaping freely). The water steam is evacuated as it is produced. This system makes it possible to absorb the excess energy during the roasting phase, in production of CO₂, it has the advantage of not being under pressure in its evaporation circuit and the water steam generated is evacuated to the ambient air. Any existing system for evacuation can be employed, provided the excess energy is thus evacuated. This system also has the advantage that it can be reversible and can be used in one of the other two configurations (1 and 2 above).

The generator G and more particularly the reactor R, comprises a grate-type furnace, which can be cooled conventionally by circulation of water or by any hydraulic heat-transfer means. The walls of the generator are also under thermal control, cooled by the same method, or configured so as to optimize heat exchange to the heat-transfer gas stream. The grate of the furnace receives the fuel in a bed of solid fuel. This bed is preferably composed of roasted plant biomass, densified or not, but can be pre-dried, anhydrous plant biomass, or a compacted form of plant biomass. Combustion is preferably effected with oxygen injected into the furnace, at the reactive centre of the biomass.

The generator can also comprise a chamber for post-combustion of the pyrolysis gases generated by the roasting and combustion of the biomass on the grate of the furnace. The system is then dedicated purely to the optimum thermal upgrading of the roasting process.

Combustion of the bed of combustible biomass can take place under O₂ as the supporter of combustion or under air as the supporter of combustion, said reactions are then carried out “ALTERNATELY and SEPARATELY”, to produce a bed of embers and thus form the “thermal base”, through which the gases extracted from the roasting furnace 10 pass, and are purified there. The gas mixture, combustion gas in below-stoichiometric conditions and pyrolysis gases, is thus brought to the ad hoc temperature for stoichiometric post-combustion.

The bed of solid fuel, called the thermal base, is composed of anhydrous biomass, preferably roasted and therefore with higher concentration of vegetable carbon. Combustion of the thermal base under O₂ as supporter of combustion permits fine control of combustion. This bed of roasted biomass burns at high temperature.

The first objective of the generator G is to produce, for the roasting system:
CO₂, which constitutes the heat-transfer gas stream used in the process (in this case the supporter of combustion of the solid biomass fuel is industrial oxygen) and
the heat used for roasting.

Combustion of the roasted biomass under O₂ is complete and only produces CO₂. The CO₂ introduces a process of heat transfer supplementary to the known processes of heat transfer. This process of heat transfer is specific to the raw material, composed of plant biomass, and is osmosis of the CO₂ with the moisture contained in the biomass.

This osmosis is made possible by the phytobiological symbiosis of the CO₂ and the “biomass” material:
C and O₂ are the essential constituents of the “biomass” material, the CO₂ (atmospheric) being its natural ingredient
the water contained in the material is the natural solvent of the CO₂

The second purpose of said generator G is to carry out complete combustion of the combustible constituents generated by the process, for upgrading its thermal potential, in order to:
optimize the energy efficiency of the process and
produce a process gas which is:
   recyclable by the process, in the system or,
   non-polluting, in the case when an excess of CO₂ would, for economic reasons, be discarded to atmosphere. It will be possible, in this case, for combustion to be carried out under air as supporter of combustion.

The CO₂ produced by combustion of plant biomass is considered to be neutral since the biomass is renewable and the same amount of atmospheric CO₂ will be used for growth of the same amount of biomass. Combustion of the biomass must therefore be complete so that the discarded CO₂ does not contribute to the greenhouse gases.

The CO₂ resulting from combustion of the biomass under O₂ passes through the primary pipes of the heat exchangers where it will transmit its heat to the heat-transfer components of the system:
heat-transfer gas stream for treatment of the wood to be roasted,
Optionally, water to be superheated and/or evaporated, for storage of thermal energy and/or co-generation of electricity.

Once cooled to a temperature below the temperature of condensation of the water steam contained in the gas<70° C., the dewatered CO₂ is filtered (to trap the carbon particles that could have been entrained in the stream). It is then in the required conditions for utilization as heat-transfer means for roasting the wood load B.

This gas is then transferred to the heat exchanger to be brought to the temperature required for the roasting treatment. The heat-transfer CO₂ is then fed into the roasting furnace 10, where it transmits its heat capacity to the wood B to be roasted. Heat transfer to the wood, according to the four processes of heat transmission defined above, raises its temperature and enables the moisture contained in the wood B to be evaporated.

The laden gas mixture (heat-transfer CO₂+water steam and then heat-transfer CO₂+VOC, extracted from the wood to be roasted) is then withdrawn from the roasting furnace 10 and transferred to the thermal generator to be:
purified through the burning “thermal base”
dried in an exchanger/dehydrator and filtered
then transferred to the heat exchanger where it acquires its new charge of process heat.

Everything takes place with continuous recycling, up to the end of roasting.

The roasting cycle of this design is carried out in conditions of total self-production of energy; only the purchase of oxygen as supporter of combustion and of the electricity used by the system (unless it is self-produced) have to be taken into account in this part of the direct operating costs.

In another operational configuration, the heat-transfer gas circuit is arranged as a closed loop, which contains the volume of heat-transfer CO₂ used for the heat exchanges in the process. The heat-transfer gas stream travelling in this circuit no longer passes through the “thermal base” reactor of the generator during the dehydration phase, but only through the exchangers where:
the heat-transfer gas stream acquires its process heat capacity,
the laden gas mixture, heat-transfer CO₂+water steam extracted from the wood to be roasted, is dried.

When the wood is dried, the laden gas mixture extracted from the wood to be roasted, heat-transfer CO₂+volatile organic compounds (VOC), then travels through the thermal reactor of the generator, for stoichiometric combustion of the VOC under O₂ as supporter of combustion. The combustion gases are composed essentially of CO₂. If they are at the right temperature for roasting, then they are fed directly into the roasting furnace 10, without any other form of treatment. If their heat capacity is excessive, then they are discharged in a heat exchanger to the benefit of a heat-transfer component dedicated to another application and/or for buffer thermal storage.

In this case combustion of the VOC can take place under atmospheric (air) supporter of combustion, this solution only being envisaged if the combustion gases are not used in the roasting process: too much heat-transfer CO₂, too much thermal energy, etc. The excess thermal energy is removed from the combustion gases in the exchanger, and they are cooled to the temperature required for discharge to atmosphere.

The condensation of H₂O simplifies the recycling and recovery of the CO₂, as the latter can be reused immediately in the process. Its purity makes it a strategic product, by substituting industrial CO₂ which is generated by chemical reactions on fossil materials and thus decreasing the impact of greenhouse gases, etc.

A portion of the CO₂ will be stored in a buffer tank, under pressure, to maintain the capacity used in process start-up. A portion can also be condensed by known systems, such as freezing-out and/or compression:
for cooling of wood at the end of the roasting cycle
for providing system safety: liquid CO₂ is a preferred means of neutralizing untimely ignition of the wood.

The CO₂ cycle can be described as follows:
1. Production of CO₂ by combustion of the carbon-containing constituents of plant biomass under O₂ as supporter of combustion (C+O₂═CO₂);
2. Treatment and purification of the combustion gas, CO₂+H₂O from the combustion of H2 contained in the plant biomass fuel,
   cooling and dehydration by a dedicated system such as a known industrial dehumidifier,
   filtration of any unburnt particles of biomass, using a filter that can be regenerated, and
   preheating of the residual CO₂, which thus becomes the gaseous heat-transfer fluid for roasting, by looping on the dehumidification system: thermal recovery of the latent heat of condensation of H₂O and of the energy for use in the dehydration system;
3. Heating of the heat-transfer gas stream, in the exchanger of the thermal generator; said stream, preheated during the preceding treatment, has sufficient heat capacity for appreciably lowering the temperature of the gas mixture received from the post-combustion chamber, before it is treated;
4. Dehydration of the wood to be roasted and extraction of the gas mixture, composed of:
   the heat-transfer stream (CO₂) and
   H₂O extracted from the wet wood to be roasted;
5. Treatment of said gas mixture through the “thermal base” of the generator;
6. Post-combustion of components that are still combustible, in the dedicated chamber, carried out by injection of O₂;
7. Transfer of energy to the heat-transfer gas stream after recycling on passing through the heat exchanger
8. Treatment and purification of this new gas mixture leaving the post-combustion chamber;
9. Recycling of the residual CO₂, which is thus once again the heat-transfer fluid for roasting;
10. Continuation of this cycle, until complete dehydration of the wood to be roasted;
11. Cycle for roasting the dried wood and extraction of the laden gas mixture, composed of:
   the CO₂ used as heat-transfer gas stream, and
   pyrolysis gases extracted from the wood to be roasted (VOC);
12. Treatment of the laden gas mixture in the thermal generator; and
13. Post-combustion of constituents that are still combustible and of the pyrolysis gases, in the dedicated chamber, carried out by injection of O₂;
14. Starting from point 11, the gases from the post-combustion chamber are recycled to the roasting furnace up to the final stage of the operation without passing through the system for treatment/dehydration/filtration. Only a portion of these gases is treated and then compressed and stored; and
15. Stopping the feed of heat-transfer CO₂ and cooling of the roasted wood load by injection of liquid CO₂, which will draw its latent heat of evaporation from the heat capacity of the load to be cooled:
   rotation of the furnace 10 is maintained during this stage, as well as the extraction of the evaporated and reheated CO₂,
   combustion of the “thermal base” is kept at idling,
   the gas mixture, cooling CO₂+combustion gas, is treated (see point 2), and
   the residual CO₂ is stored and/or liquefied.

Once the total CO₂ capacity is reached, combustion within the thermal generator can be carried out under atmosphere. This situation does not prevail if the excess combustion gas is not utilized in a total system with energy self-sufficiency or in ancillary applications.

In an existing conventional method, with the starting wood at 45% moisture (with lower heating value (LHV) of 7900 kJ/kg) it is necessary to supply 3690 kJ per kilogram (kg) of raw material for roasting it (latent heat of dehydration+sensible heat of roasting). The 0.44 kg of roasted product originating will have an LHV of 10 331 kJ (or an LHV/kg of 23 480 kJ/kg), which gives an overall energy efficiency (except combustion efficiency linked to the performance of the generator) of 10 331 kJ minus the 3690 kJ consumed=6641 kJ per kg of wet raw material (B1).

In the method according to the invention, the water steam extracted from the starting wood at 45% moisture is partly reduced on passing through the “thermal base” of the generator. The resultant gas mixture is thermally reactive: it holds, in its formulation, the “exhaustive” principles of restitution of the energy employed in the process. The combustion of these components can thus be optimized in the post-combustion chamber, where heat exchange with the heat-transfer gas stream is at its optimum:
losses in the system reduced to an acceptable level, and
markedly reduced temperature of the residual gas mixture (combustion gas+H₂O) before its transfer to the dehydration system.

It can therefore be stated that with starting wood at 45% moisture, we no longer consider the lower heating value of 7900 kJ/kg, as is the case in the conventional methods, but the HHV of the components contained in the anhydrous wood, i.e. 23 600 kJ/kg since:
the method utilizes water steam produced as a reactive thermal component,
the method and the system according to the invention are designed for recycling of CO₂ and therefore recovery of at least a portion of the energy of evaporation of the water contained in the raw material,
the method only consumes the energy required for compensating the heat losses of the generator/roaster system.

Finally, a roasted product will be obtained, per kg of raw material employed for roasting, LHV of which will also be 10 331 kJ, but as there is an excess in the energy balance of the process (combustion of the VOC and direct utilization of the energy generated) the process is considered not to have consumed anything for the reaction.

One kilogram of raw material (starting wood) is therefore upgraded from 7900 kJ to 10 331 kJ, or a gain of 30.77%.

Relative to the “conventional” methods of roasting (for which the LHV of the amount of material roasted is disconnected from the energy employed for the process, i.e. a final LHV of 6641 kJ), the gain is 55.58%.

Relative to forestry chips, supplied wet for feed to installations for energy production using plant biomass, the environmental benefits associated with the life cycle of the roasted wood used as energy-producing wood, are:
limitation of atmospheric emissions just to the “neutral”, excess CO₂,
energy density is more consistent, allowing savings in transport, storage and logistics of supplying thermal power stations,
absence of re-uptake of moisture during storage, therefore smoothing out the constraints of using biomass “energy” linked to seasonality and the risks of ignition of stocks,
improvement of the combustion efficiency of the thermal generator,
improvement of the overall thermal efficiency of the power station,
reduced investment for the systems employed for new installations, and
appreciable reduction in the amount of raw material taken from the source, for an equivalent energy return.

This system for roasting plant biomass can be arranged in a battery of cylindrical assemblies, to satisfy the continually varying demand for roasted wood.

The advantage of this system is that the cylindrical roasting assemblies can be dimensioned for a standardized unit capacity. Arranged in a battery, they will be supplied and controlled by a single system for thermal generation/utilization of the pyrolysis gases and one and the same system for management of the CO₂ produced.

The invention is not limited to the example that has just been described, but can be applied to the roasting of all plant biomasses.

1-53. (canceled)

54. A method for roasting a load of plant biomass, comprising the following stages:
generation of a treatment gas stream by thermal generating means, said treatment gas stream being an inert gas consisting essentially of CO₂;
generation of a bed of material at high temperature, called the thermal base;
treatment of said load of biomass with said treatment gas stream, said treatment gas stream being laden with gaseous components comprising water steam and volatile organic compounds originating from said load of biomass during said treatment; and
recycling of at least a portion of said water steam by passing at least a portion of said laden gas stream through said thermal base.

55. The method according to claim 54, characterized in that the reactive thermal base is essentially composed of carbon-containing constituents at high temperature obtained by combustion under O₂ of dried biomass.

56. The method according to claim 54, characterized in that the thermal base is burning at a temperature that is controlled by injection of oxygen in the center of said base.

57. The method according to claim 54, characterized in that it additionally comprises combustion, during passage of the laden gas stream through the thermal base, of organic gaseous components originating from the load of biomass and present in said laden gas stream, said combustion producing thermal energy that can be used directly in the method and/or electric power by means of dedicated systems.

58. The method according to claim 54, characterized in that it further comprises recycling of the laden gas stream to recover the gas that can be used in the treatment gas stream, said recycling comprising a filtering of the laden gas stream, after the passage of said stream through the thermal base.

59. The method according to claim 54, characterized in that the generation of the gas stream for roasting comprises:
a combustion of roasted biomass under O₂, said combustion producing a combustion gas consisting essentially of CO₂, and
a condensation of H₂O components contained in the combustion gas, in order to recover a residual gas consisting essentially of carbon dioxide CO₂.

60. The method according to claim 59, characterized in that the residual gas travels through at least one heat exchanger to acquire the treatment temperature, and then is returned to the treatment cycle, to be used in the treatment of the load of biomass to be roasted, the thermal energy necessary for raising the residual gas to the treatment temperature is obtained by combustion of dried biomass.

61. The method according to claim 54, characterized in that the treatment gas stream is generated by combustion of a solid fuel, said combustion also generating at least a portion of the thermal base.

62. A system for roasting a load of plant biomass, comprising:
generating means provided for generating an inert treatment gas stream consisting essentially of CO₂ and a bed of material at high temperature, called the thermal base;
a treatment unit, provided for receiving and subjecting said load of biomass to said treatment gas stream, said treatment unit comprising a treatment furnace and means for feeding the load of biomass into said treatment furnace and for removing said load of biomass from said treatment furnace; and
gas exchange means provided for communication between the generating means and the treatment unit.

63. The system according to claim 62, characterized in that the generating means comprise a thermal generator provided for generating:
at least a portion of the treatment gas stream, and
at least a portion of the thermal base
said generator comprising a thermal reactor or a solid-fuel furnace or alternatively a hybrid device, allowing the combustion of a solid fuel and a gaseous fuel.

64. The system according to claim 63, characterized in that the thermal generator is equipped with a system for cooling by circulation of a heat-transfer fluid.

65. The system according to claim 63, characterized in that the thermal generator comprises a grate-type furnace provided for receiving the thermal base and arranged for effecting the transfer of the laden gases originating from the treatment unit.

66. The system according to claim 63, characterized in that the thermal generator comprises means for injecting oxygen.

67. The system according to claim 63, characterized in that the thermal generator comprises a chamber for post-combustion of pyrolysis gases generated by the roasting of the load of biomass and/or by the incomplete combustion of a solid fuel.

68. The system according to claim 63, characterized in that the thermal generator comprises at least one heat exchanger, said heat exchanger being provided for effecting heat exchange between either a combustion gas and the treatment gas stream, or a fluid composed essentially of saturated water steam and the treatment gas stream, said fluid being essentially composed of water steam originating either from the roasting of the load of biomass or from a cooling circuit of a part of said system.

69. The system according to claim 62, characterized in that the furnace is a cylindrical assembly comprising an inner cylinder housed in an outer cylinder defining a space for treatment of the load of biomass, said inner cylinder being provided with freedom to rotate about a longitudinal axis relative to the outer cylinder and receiving the load of plant biomass to be roasted.

70. The system according to claim 69, characterized in that the inner cylinder comprises an inside wall which is perforated and at least one protuberance on said inside wall, said protuberance ensuring entrainment and mixing of the load of biomass during the treatment.

71. The system according to claim 69, characterized in that the outer cylinder has a heat-insulated shell and a solid inside wall enveloping the inner cylinder and delimiting the treatment space of the biomass feed.

72. The system according to claim 69, characterized in that the treatment furnace comprises a deflector on almost the entire length of the cylinder intended for directing the treatment gas stream towards the lower portion of the treatment space so as to distribute said stream onto all of the load of biomass.

73. The system according to claim 69, characterized in that the treatment furnace has at least two brushes mounted in contact on the one hand with the inside wall of the outer cylinder and on the other hand between the outside wall of the inner cylinder so as to delimit a zone for feed of the treatment gas stream into the treatment furnace and a zone for extracting the gas stream after treatment of the load of biomass, said brushes being arranged for brushing the outside wall of the inner cylinder so as to dislodge particles of the load of biomass clinging to the inner cylinder.

74. The system according to claim 69, characterized in that the treatment unit further comprises driving means arranged for providing rotation of the inner cylinder about a longitudinal axis.

75. The system according to claim 69, characterized in that one end of the inner cylinder and of the outer cylinder is provided with an opening permitting introduction of the load of biomass into the inner cylinder before the treatment and extraction of said load of biomass after the treatment, the other end being closed, said opening being tightly closed by sealing means actuated by piston means.

76. The system according to claim 69, characterized in that:
in a position called the charging position, the cylindrical assembly is positioned vertically, the end having an opening in the inner cylinder and outer cylinder that is at the top, in such a way that the load of biomass to be treated can be fed into the inner cylinder,
in a position called the process position, the cylindrical assembly is positioned horizontally, the opening of the inner cylinder and outer cylinder is tightly closed by the sealing means, and
in a position called the discharging position, the cylindrical assembly is positioned vertically, the end having an opening of the inner cylinder and outer cylinder that is positioned at the bottom, in such a way that the load of biomass treated is collected in receiving means.

77. The system according to claim 69, characterized in that it further comprises means for extracting the gas mixture from the treatment space, provided so that said treatment space is kept at a slight low pressure.
